(19) United States
(12) Patent Application Publication
(10) Pub. No.: US 2017/0116955 A1
(43) Pub. Date: Apr. 27, 2017

(54) METHOD OF MAPPING SOURCE COLORS OF A SOURCE CONTENT

(71) Applicant: THOMSON LICENSING, Issy les Moulineaux (FR)

(72) Inventors: Jurgen STAUDER, MONTREUIL/ILLE (FR); Jonathan KERVEC, PAIMPONT (FR); Luis Eduardo GARCIA CAPEL, LA ALBATALIA (Murcia) (ES)

(73) Assignee: THOMSON LICENSING, Issy les Moulineaux (FR)

(21) Appl. No.: 15/318,187

(22) PCT Filed: Jun. 11, 2015
(86) PCT No.: PCT/EP2015/063099

§ 371 Date: Dec. 12, 2016

(30) Foreign Application Priority Data
Jun. 12, 2014 (EP) 14305892.3

(51) Int. Cl. G09G 5/02; H04N 9/12; H04N 1/60

(52) U.S. Cl. CPC G09G 5/02; H04N 1/6066; H04N 9/12; G09G 2340/06; G09G 2320/0673

(57) ABSTRACT

Method of mapping source colors of a source content represented by source coordinates comprising: —applying a reference display forward color transform characterizing a reference display device, —applying a virtual display inverse color transform configured to model a virtual display device having approximately the same color primaries as a mastering display device used to master said source content.

### TECHNICAL FIELD

The invention is in the field of methods and systems for color correcting to provide predictable results on displays with different color gamuts. The invention concerns notably a method for color gamut mapping using linear models and metadata on the color gamut.

### BACKGROUND ART

When images are created in motion picture, broadcast or other video workflows, the color of the images is verified using a mastering display while finally the images will be watched on other displays, for example in theatres, on TV screens or on a tablet.

For example, a graphics arts creator verifies the colors on the monitor of his workstation while the final reproduction will be printed on paper. In this case, the workstation monitor is the mastering display device and the paper printer is the final reproduction device. Another example is capture of images on argentic film, scanning images of this film and color correction of the scanned images. The film is scanned using a dedicated high-resolution color correction device. The operator applies color correction and verifies the result on a high definition control monitor while the final color reproduction will be again a film printed on a film printer and the images projected by a film projector. Here, the control monitor is the mastering display device and the film printer and film projector are the final reproduction devices. In another case, broadcast content is prepared on a high grade production monitor but then reproduced on the screen of a consumer TV set. The high grade production monitor is the mastering display and the consumer TV is the final reproduction device.

Color differences between what is shown by the mastering display device used in production and what is shown by the final reproduction device is the general problem addressed in this invention. These color differences can include changes of hue, changes of color saturation, changes of contrast, changes of light intensity, changes of dynamic range, and changes of color gamut.

A solution to this problem of color differences is color management (CMM). For CMM, the color characteristics of the mastering display device and of the final reproduction device are measured, mathematically modeled and then compensated in a manner known per se using a color transformation which is the basis of the CMM. CMM takes notably into account the difference between the color gamut of mastering display device and the color gamut of the final reproduction device. The color gamut describes the totality of reproducible colors of a device. When an image to reproduce contains colors that are outside the gamut of the final reproduction device or close to its border, the applied color transform(s) used to implement CMM may contain a specific processing such as color compression or color clipping to move this color inside this gamut or on its border. This processing is called gamut mapping.

A simple and widely used way to implement such color management is gamut clipping. All colors that are outside the color gamut of the final reproduction device (for instance a target display device) are clipped to colors on the border of the color gamut of this device. Such a clipping is often performed in the device dependent color space of the reproduction device as shown in FIG. 1. Device dependent input RGB color coordinates representing a color in the color space of the mastering display device are transformed into device independent XYZ color coordinates using a linear matrix based notably on the primaries of this mastering display device, this matrix being computed for instance such as described in the Recommended Practice 177 of the SMPTE. These device independent XYZ color coordinates represents the same color in the CIEXYZ color space. As illustrated on FIG. 1, in this color space, no operation, no gamut mapping is carried out. Then, XYZ coordinates are transformed into RGB coordinates representing now this color in the color space of the final reproduction display device, using a linear matrix based notably on the primaries of this final reproduction device, this matrix being computed again such as described in the RP 177. Colors that are outside the color gamut of the final reproduction device will then result in RGB color coordinates that are out of the range of coordinates which are valid for the control of this final reproduction device. These out-of-range coordinates are then simply clipped or clamped to the color range limits of the reproduction device. For example, in HDTV systems, RGB color coordinates are encoded in 8 bits. The valid range for these coordinates is then between 0 and 255. If a coordinate exceeds this range, it will be clipped to either 0 (lower limit) or 255 (higher limit).

Gamut mapping is usually more complex than just clipping. It maps colors from a source color gamut (for example the color gamut of a mastering display device) into a target color gamut (for example the color gamut of a final reproduction device). Instead of being linked to a mastering display device, the source color gamut might also be linked to an image capture device such as a camera or a scanner. Notably when these colors are received through a standardized channel, for instance a broadcast channel, and/or are provided through digital decoding, the source color gamut might be linked to a standard such as ITU-R BT.709. Such source color gamuts will be named below “reference color gamuts”. The source color gamut might also be linked to a medium such as film or paper prints.

Gamut mapping also acts on the intensity (i.e. luminance or lightness) of colors and includes so-called tone mapping. Gamut mapping may even consist only of tone mapping (i.e. for instance lightness mapping), if the white and black levels of the mastering display device and of the reproduction device are very different and/or if viewing conditions in front of the mastering display device differs from viewing conditions in front of the reproduction device.

Gamut mapping has an impact on color reproduction. Two kinds of reproduction are generally distinguished: colorimetric and non-colorimetric. The colorimetry of a color is measured by the XYZ coordinates of this color, using notably a colorimeter. Colorimetric color reproduction aims to reproduce a color on a target display device (i.e. final reproduction device) such that its colorimetry is identical or as close as possible to the colorimetry of a reference or mastering display device. On the opposite, gamut mapping, by principle, involves non-colorimetric color reproduction since at least some of the colors to reproduce are mapped.

Usually, color gamut mapping is carried out in specific color spaces. Some methods use the L*a*b* space defined by the CIE in 1976. In L*a*b* space, a constant a*b* angle is assumed to correspond to identically perceived hue. The L* coordinate represents the intensity or lightness. Unfortunately, this color space was shown to not well represent all hues, notably in blue tones. Other methods use the JCh space defined in the CIECAM-02 standard defined by the CIE in 2002. In JCh space, the h coordinate is assumed to correspond to perceived hue by the human eye and the J coordinate is assumed to correspond to perceived light intensity. JCh space was shown to better represent hues and intensity than L*a*b*. When performing gamut mapping in L*a*b* space, the classical approach is shown in FIG. 2. First, device independent XYZ color coordinates are transformed into L*a*b* coordinates according to well-known formulas specified by the CIE. Then, gamut mapping is carried out in L*a*b* space. Then, mapped L*a*b* coordinates are transformed to device independent XYZ color coordinates representing the mapped color in the CIE XYZ color space. The L*a*b* gamut color space has the advantage that color mapping can generally be represented on lines within planes of constant hue, or of constant saturation, or of constant lightness. Other psychovisual spaces can be used for color mapping, for example JCh.

A specific situation of color gamut mapping concerns content with large color gamut and/or with high dynamic range.

A first situation of color mapping concerns, for example, a Ultra High Definition TV (UHDTV) content which is encoded according to the standard ITU-R BT.2020, known as having a wide color gamut, after being mastered by a LCD monitor having a color gamut narrower than the wide color gamut of encoding standard. It might occur that some colors of the UHDTV content encoded according to the ITU-R BT.2020 standard are not actually used during the mastering, notably because some colors of the UHDTV content that can be encoded according to ITU-R BT.2020 cannot be reproduced by the mastering display device, i.e. by the LCD monitor.

A second situation of color gamut mapping concerns, for example, a High Dynamic Range (HDR) content which is encoded according to a HDR standard having an extended range of color values, after being mastered by a LCD monitor having a low range of color values, namely lower than the extended range of the encoding standard. It might occur that some colors (notably luminances of these colors) of the HDR content encoded according to this HDR standard are not actually used during the mastering, notably because some colors (notably luminances) of the HDR content that can be encoded according to this HDR standard cannot be reproduced by the mastering display device, i.e. by the LCD monitor.

For the management of colors in the above two situations with UHDTV content and/or HDR content, we have now three color gamuts: First, the color gamut of the mastering display device or the color gamut of the content itself. Second, the color gamut used for the encoding and/or the transmission of the UHDTV or HDR content. More generally, this color gamut will be named reference color gamut. Third, the target color gamut of the device used for the reproduction of the content after decoding, here the consumer TV set. The color gamut of the mastering display device and the color gamut of the content are generally smaller than the reference color gamut.

If the colors of the UHDTV and/or HDR content are delivered directly to the consumer TV set without any other information except that concerning the reference color gamut of these colors, the CMM implemented for the consumer TV set does not know anything about the mastering display device and will take the reference color gamut used for the encoding as a source color gamut, i.e. as the color gamut of the colors of this content, although these colors have been generated using a mastering display device having another color gamut. It means that the content to be reproduced by a target display device is received in a format which is generally not adapted for a reproduction by this target display device but for a reproduction by what will be named a “reference display device” (see below). Before being reproduced by the target display device, an adaptation of the content will then be needed if the reproduction should be done by the target display device. As a matter of fact, if one wants that the CMM takes into account the color gamut of the mastering display device, this color gamut has to be sent to the consumer TV set as metadata that should be used for the color mapping of the UHDTV and/or HDR content towards the target color gamut, before being reproduced by the reproduction device. As shown below, the invention will deal with this problem.

More generally, the color gamut of the UHDTV content and/or HDR content is encoded in a reference color gamut which is generally defined by a specific standard such as ITU-R BT.709 or such as ITU-R BT.2020 as mentioned above. This specific standard generally defines a forward color transform and/or an inverse color transform, therefore defining, at least implicitly, a theoretic display device that will be named hereinafter a reference display device.

In a general typical application known from prior art in the field of reproduction of colors of a content provided in a reference or encoding color gamut, gamut mapping is generally performed from this reference or encoding color gamut towards the color gamut of a target display device used to reproduce this content.

Being mastered or not, source colors of the content are encoded in device dependent color coordinates representing these colors in the color space of a display device having the encoding and/or transmission color gamut as color gamut. As described above, this display device is named reference display device. The gamut of the source content gamut as the gamut of the mastering display device are generally smaller or equal to the encoding color gamut, i.e. the reference color gamut. As in the general typical application above, the color gamut of the target display device used to reproduce source colors of the content is smaller than the reference color gamut. But, in this specific application that the invention addresses, the color gamut mapping aims at mapping any color located in the source color gamut into the color gamut of the target display device.

In the PLCC models modelling color display devices (Piecewise Linear interpolation assuming Constant Chromaticities), it is assumed that:

the chromaticities of the primaries of the display device are constant,

there is no interaction between the different color channels of this display device.

A superset of PLCC models are described in the Recommended Practice 177 of the SMPTE entitled “Derivation of Basic Television Color Equations” published in 1993, this superset allows additionally incorporating an explicit white point of this display device into the model.

PLCC and RP177 models of a display device comprise both two steps. At first, input digital RGB values of the R, G and B channels of the display device are linearized, then a linear transformation using for instance a matrix is applied to these linearized RGB values to get the CIEXYZ color coordinates of a color reproduced by the display device when entering these input digital RGB values.

The linearization of RGB channels can be performed using a so-called “EOTF”, i.e. Electro-Optical Transfer Function. Such a linearization function may also be called Electro-Optical Conversion Function, or Tone Reproduction Curve (TRC). Annex 1 of the Recommendation ITU-R BT.1886 published in March 2011 gives more details about definition of EOTF.

In the first step of a PLCC or RP177 model of a color display device, the input digital color values R, G and B of the different color channels are linearized into linear values Rₗ, Gₗ and Bₗ by an EOTF specific to this device.

In the second step of a PLCC or RP177 model, these linear values Rₗ, Gₗ and Bₗ are transformed through a matrix into, for instance, X, Y and Z values representing the color coordinates of the color channels in the CIE XYZ color space. Other trichromatic, linear color spaces than XYZ could be used. For example, if Rs, Gs, Bs are the color coordinates of a specific trichromatic, linear color space having three specific color primaries, RP 177 allows to transform X, Y, Z color coordinates into Rs, Gs, Bs coordinates. By concatenating the transformation of Rₗ, Gₗ and Bₗ into X, Y, Z and X, Y, Z into Rs, Gs, Bs, a single linear transform can be built transforming directly Rₗ, Gₗ and Bₗ into Rs, Gs, Bs, When used in this way, Rs, Gs, Bs color coordinates can be considered as device independent such as X, Y, Z color coordinates. For the first step of a PLCC or RP177 model, we have then (RₗGₗBₗ)=EOTF_{D}(R G B), where EOTF_{D} is the EOTF of the modelled display device.

In case of a PLCC model, we have for the second step:

$$[ \begin{matrix}X \\ Y \\ Z\end{matrix} ] = {IM}_{D} [ \begin{matrix}{R}_{l} \\ {G}_{l} \\ {B}_{l}\end{matrix} ] with {IM}_{D} = [ \begin{matrix}{X}_{D - R} & {X}_{D - G} & {X}_{D - B} \\ {Y}_{D - R} & {Y}_{D - G} & {Y}_{D - B} \\ {Z}_{D - R} & {Z}_{D - G} & {Z}_{D - B}\end{matrix} ]$$

where X_{D-R}Y_{D-R}Z_{D-R}, X_{D-G}Y_{D-G}Z_{D-G} and X_{D-B}Y_{D-B}Z_{D-B} are the XYZ color coordinates of, respectively, the Red, Green and Blue primaries of this display device, when linear values Rₗ, Gₗ and Bₗ are all normalized to be a value in the interval [0,1].

In case of a RP177 model, additionally the chromaticity coordinates x_{D-W}, y_{D-W} of the white point of the display device in the xy chromaticity space of the CIE are introduced such that the second step is defined as follows:

$$[ \begin{matrix}X \\ Y \\ Z\end{matrix} ] = {M}_{D} [ \begin{matrix}{R}_{l} \\ {G}_{l} \\ {B}_{l}\end{matrix} ] with {M}_{D} = {IM}_{D} {W}_{D}$$

$$where {W}_{D} = [ \begin{matrix}{w}_{D - R} & 0 & 0 \\ 0 & {w}_{D - G} & 0 \\ 0 & 0 & {w}_{D - B}\end{matrix} ]$$

$$and [ \begin{matrix}{w}_{D - R} \\ {w}_{D - G} \\ {w}_{D - B}\end{matrix} ] = {IM}_{D}^{- 1} [ \begin{matrix}{x}_{D - W} / {y}_{D - W} \\ 1 \\ {z}_{D - W} / {y}_{D - W}\end{matrix} ] and {z}_{D - W} = 1 - {x}_{D - W} - {y}_{D - W} .$$

As a whole, it means that the relationship between a forward transform FT_{D} characterizing a color display device D and an EOTF_{D} combined with a matrix M_{D} also characterizing this display device is as follows:

FT_{D} (RGB)=IM_{D} [EOTF_{D} (RGB)] when using PLCC model, or FT_{D} (RGB)=M_{D} [EOTF_{D} (RGB)] when using RP177 model, with M_{D}=IM_{D}W_{D}.

Similarly, it means that the relationship between an inverse transform IT_{D} characterizing a color display device D and an EOTF_{D} combined with a matrix M_{D} also characterizing this display device is as follows:

IT_{D} (XYZ)=EOTF⁻¹_{D} (IM⁻¹_{D}[XYZ)] when using PLCC model, or IT_{D} (XYZ)=EOTF⁻¹_{D} (M⁻¹_{D}[XYZ)] when using RP177 model.

As a whole, when using the PLCC model, a display device can be characterized by its EOTF and the XYZ color coordinates of its primaries. When using the RP177 model, the xy chromaticity coordinates of the white point of this display device should be added for its characterization.

### SUMMARY OF INVENTION

A goal of the invention is to adapt the source colors of a source content which are encoded to be reproduced by a reference display device to the target color gamut of a target display device. More specifically, an aim of the invention is to better distribute colors to reproduce by the target display device in the color gamut of this device. This requires an adaptation of the content through a specific color gamut mapping of these source colors that that is described in detail below. These source colors may be notably provided:

in the reference device-dependent color space of this reference display device, whereas they are represented in R,G,B color coordinates in the reference device-dependent color space, or

in a device-independent color space, whereas they are then represented in X,Y,Z color coordinates in this color space.

The invention will be described hereinafter separately in each of these situations.

The first situation where source colors are represented in the reference device-dependent color space by trichromatic color coordinates R,G,B—respectively for the red, the green and the blue—will now be described. It means that, if the so-called reference display device is controlled by these color coordinates R,G,B, it will reproduce the source colors. This reference display device may correspond for instance to a standard such as ITU-R BT.2020. The reference display device may be different or identical to the mastering display device.

In this first situation, a subject of the invention is a method of mapping source colors of a source content, wherein said source colors are represented by device-dependent source coordinates R,G,B in the reference device-dependent color space of a reference display device characterized by a reference display forward color transform comprising:

applying said reference display forward color transform to device-dependent source coordinates R,G,B representing said source colors, resulting in device-independent source coordinates X,Y,Z representing the same source colors in a device-independent linear color space,

applying a virtual display inverse color transform IT_{VD} to said resulting device-independent source coordinates X,Y,Z representing said source colors, resulting in device-dependent mapped coordinates R′,G′,B′ representing mapped colors in said reference device-dependent color space,

wherein said virtual display inverse color transform IT_{VD} models a virtual display device characterized by the same primaries as the primaries of a mastering display device used to master said source content or by primaries extracted from a description of the color gamut of said source content.

FIG. 4 illustrates a general embodiment of this method. Again, the mapping method according to the invention processes source colors that are supposed to have been mastered using a mastering display, although the characteristics of this mastering display may not be known when receiving these source colors. The source colors are thus generally within the unknown color gamut of this mastering display. By definition, the mastering display is able to reproduce all source colors.

As shown on FIG. 4, the method according to the invention first transforms these R,G,B color coordinates of source colors into device independent color coordinates X,Y,Z using the forward transform of the reference display device. By definition, the forward transform of the reference display device is able to transform R,G,B color coordinates used to control the reference display into X,Y,Z color coordinates representing in the CIE XYZ color space the color that the reference display reproduces when controlled by these R,G,B color coordinates. In a second step of the method, the inverse transform of a virtual display device is applied to the X,Y,Z color coordinates obtained at the previous step above. By definition, this inverse transform is capable to process the X,Y,Z coordinates of any colors that are within the color gamut of this virtual display device. This virtual display device is notably characterized by primary colors that are the same as those of the mastering display device, if it is known, or that are those of the content, corresponding to those extracted from a description of the color gamut of the content to map. The primary colors of the mastering display and/or the description of the color gamut of the content are preferably available as metadata, preferably transmitted with the content to reproduce. Other possible characteristics defining this virtual display device are detailed below.

In some cases, mapped colors that are obtained from the mapping of this general embodiment illustrated on FIG. 4 might not be inside the reference display color gamut. This might be due to the mentioned remaining differences of color gamuts between virtual and mastering display. Another reason could be that some source colors are outside of the color gamut of the mastering display. In this case, an additional remapping would be required after the virtual display inverse transform. This remapping would then remap those mapped colors that are outside the color gamut of the reference display into the color gamut of the reference display. A possible remapping is clipping such as shown in FIG. 1.

A technical effect of the mapping of this general embodiment is that source colors are transformed into mapped colors that are better distributed over the whole reference color gamut. It infers that these mapped colors will then also better distributed over the whole target color gamut. An example of this technical effect of the invention is illustrated on FIG. 6 which shows, in the same RGB color space of the reference display device, source colors (left drawing) concentrated in a central part of the reference color gamut and the corresponding mapped colors (right drawing) distributed over the whole reference color gamut. In this example, the mapping corresponds to a color expansion in this RGB color space.

Advantages:
Colors are mapped without using explicit geometric operations but only deterministic linear and non-linear processing.
The first transform according to the general embodiment illustrated on FIG. 4 does not require processing of any “out of gamut” colors since by definition all source colors are within the reference color gamut.
The second transform according to the general embodiment illustrated on FIG. 4 does require processing only for very few colors since the source colors are by definition within the mastering display color gamut and the virtual display color gamut is very close to the mastering display color gamut since the virtual display has the same primaries than the mastering display color gamut.

In a first variation, the virtual display device is further characterized by an EOTF corresponding to that of a mastering display device used to master said source content, preferably further characterized by a white point corresponding to that of said mastering display device. It then means that the application of said virtual display inverse color transform is closed to the application of the mastering display inverse color transform characterizing this mastering display device.

FIG. 7 illustrates this first variation of the method illustrated in FIG. 4, in which the virtual display device is also defined by its white point and its EOTFs. This variation is characterized in that the virtual display has the same white point and the same EOTFs as the mastering display device. In general, the white point of a display is the color that a display produces if it is controlled by device dependent color coordinates that are all at maximum signal level. In general, the electro-optical transfer function (EOTF) of a display device is the relation between the luminance produced by a display with respect to the signal levels of color coordinates R, G and B applied to the different color channels used to control this display device. As reminded above in reference to PLCC and RP177 models, an additive, trichromatic display device is notably characterized by three EOTFs, one for each color channel. The first EOTF defines the contribution of given R on X,Y,Z when G and B are set to minimum signal level. The second EOTF defines the contribution of given G on X,Y,Z when R and B are set to minimum signal level. The third EOTF defines the contribution of given B when R and G are set to minimum signal level. The three EOTFs can be identical, such as defined for example by the standard ITU-R BT.2020.

In a second variation, said virtual display device is further characterized by an EOTF corresponding to that of said reference display device, preferably further characterized by a white point corresponding to that of said reference display device. FIG. 8 illustrates this second variation of the method illustrated on FIG. 4. This variation is characterized in that the virtual display device has the same white point and the same EOTFs as the reference display device although its primaries are still those of the mastering display device. In this way, the virtual display has hybrid characteristics, partly from the mastering display—for the primary colors—and partly from the reference display—for EOTF and white point.

As a variant, the virtual display may have additional characteristics such as cross channel non-linearities, as opposed to additive displays which have no cross channel non-linearities and are fully defined by the three primary colors, the white point and the three EOTFs (see PLCC and RP177 models above). Here, such cross channel non-linearities is the non-linear, cross influence of two color coordinates on the reproduced color.

There are several advantages of this second variation shown in FIG. 8 of the method illustrated in FIG. 4. A first advantage is, as already mentioned, that source colors within a mastering display color gamut are transformed into mapped colors that are approximately still within the color gamut of the reference display. A second advantage is that such a mapping does not change the white point as well as the overall contrast of the content. As mentioned, the white point is the color that a display produces if it is controlled by device dependent color coordinates that are all at maximum signal level. Since the virtual display has the same white point as the reference display, the mapping outputs color coordinates R′,G′,B′ each at maximum signal level when the input color coordinates R,G,B are each at maximum signal level. If the white point is defined only by its chromaticity coordinates but not by its amplitude or intensity, this relation still applies up to a scaling factor. The EOTF mainly impacts the intensity and contrast of colors. If a trichromatic display device is characterized by three different EOTFs, the EOTFs impact also the hue and the saturation of colors. Since the EOTFs of the virtual display device are identical to those of the reference display device, the EOTFs will not cause a change of hue and saturation of colors. Additionally, the overall contrast is preserved, too. For example, a grey ramp of colors is not modified and thus preserved by this second variation.

FIG. 9 illustrates an application of the method of FIG. 4 for the reproduction of source colors on a target display device characterized by a target inverse transform. The color content to be reproduced is produced using a mastering display device, characterized notably by its primary colors. However, the colors of the source content are encoded in R,G,B color coordinates representing these colors in the color space of a reference display device. Such color coordinates are named reference display dependent color coordinates. The reference display device is a display device that is compliant to the encoding standard of the video system in which the target display is integrated. For example, the encoding standard is a ITU-R BT.2020 if the video system is based in the ITU-R BT.2020 standard.

In well-known video systems, reference source colors are generally directly reproduced on a target display device without being previously mapped as described herein. Since these source colors are encoded in reference display dependent color coordinates, in order to get a good reproduction of source colors, the target display device needs to be compliant with such reference display dependent color coordinates. For example, the reference and target display devices could be compliant with ITU-R BT.2020 accepting color coordinates compliant with ITU-R BT.2020 and having a color gamut compliant with ITU-R BT.2020. However, the color gamut of typical target display devices is often not fully compliant and differs sometimes a lot from such an encoding standard. Typical target display devices therefore apply often target display color gamut mapping that compresses or expands the reference display color gamut to fit the target display color gamut. Notably in this case, the method shown in FIG. 9 will advantageously allow a good reproduction of the source colors although the color gamut of the target display used to reproduce these colors is different from the color gamut of the display corresponding to the encoding standard.

Another subject of the invention is then a method for reproducing a source content on a target display device characterized by a target display inverse color transform, comprising

receiving device-dependent source coordinates R,G,B representing source colors of said source content in the reference device-dependent color space of a reference display device characterized by a reference display forward color transform,

receiving metadata representing color primaries of a mastering display device used to master said source content or extracting color primaries from a description of the color gamut of said source content,

using a virtual display inverse color transform IT_{VD} modelling a virtual display device characterized by said color primaries, mapping said source colors into mapped colors according to the mapping method above that results in device-dependent mapped coordinates R′,G′,B′ representing said mapped colors,

applying said reference display forward color transform to said device-dependent mapped coordinates R′,G′,B′, resulting into device-independent mapped coordinates X′,Y′,Z′ representing said mapped colors in device-independent color space,

gamut mapping said device-independent mapped coordinates X′,Y′,Z′ from said reference color gamut towards said target color gamut and applying said target display inverse color transform to said gamut-mapped device-independent mapped coordinates X″,Y″,Z″, resulting into device-dependent target coordinates R″,G″,B″ representing said mapped colors in the target device-dependent color space of said target display device,

controlling said target display device by inputting said device-dependent target coordinates R″,G″,B″, resulting in the reproduction of said source content.

Such a method used to reproduce source colors and illustrated in FIG. 9 comprises two parts. In the first part, the mapping method illustrated in FIG. 4, or any of its variants, is applied resulting in second reference display dependent color coordinates R′G′B′ representing mapped colors in the color space of the reference display device.

The second part of the color reproduction method, taken by its own, is already well-known. Reference forward color transform characterizing the reference display device is applied to reference display dependent color coordinates R′,G′,B′ resulting in X′,Y′,Z′ device independent color coordinates representing mapped colors in the CIE XYZ color space. Then, well-known gamut mapping is applied in order to ensure that all colors that can be encoded can be reproduced by the target display device. Often, gamut compression is applied resulting in reduced saturation and reduced contrast. This gamut mapping results in X″,Y″,Z″ device independent color coordinates representing colors that are within the target display color gamut. Then, finally, the target display inverse transform is applied to these X′,Y′,Z′ device independent color coordinates, resulting in third R″,G″,B″ color coordinates that are target display dependent, and that represent mapped colors in the color space of the target display device, and that are used to control the target display device to reproduce the source colors. In this way, the mapped color defined by reference display dependent R′G′B′ color coordinates is reproduced on the target display.

The method shown in FIG. 9 solves this issue thanks to the first part of the color reproduction method. For example, if the target display device has a color gamut smaller than that of the mastering display device, the first part of the color reproduction method has the effect of an expansion of colors and the second part has the effect of a compression of colors, the compression being stronger than the expansion. The loss of saturation generated by the second part is partly compensated by a gain of saturation generated by the first part. Other cases exist where the target display device has a color gamut that is larger than that of the mastering display device. For example, the first part of the method may then have the effect of an expansion of colors and the second part would have the effect of a compression of colors, the compression being weaker than the expansion. Other cases exist where the target display device has a color gamut that is larger than that of the reference display device. For example, the first part of the method may then have the effect of an expansion of colors and the second part would have the effect of an expansion, too.

The second situation where source colors are represented in a device-independent color space by trichromatic color coordinates X,Y,Z will now be described. In this second situation illustrated in FIG. 10 the mapping method processes source colors that are available in device independent color coordinates X,Y,Z. In this case, the already mentioned virtual display inverse transform is applied first, resulting in reference display dependent color coordinates R,G,B. Then, device independent X′,Y′,Z′ color coordinates are calculated by the application of the reference display forward transform.

Then, another subject of the invention is a method of mapping source colors of a source content, wherein said source colors are represented by first device-independent source coordinates X,Y,Z in a device-independent color space comprising:

applying a virtual display inverse color transform IT_{VD} to said device-independent source coordinates X,Y,Z representing said source colors, resulting in device-dependent source coordinates R,G,B representing mapped colors in the reference device-dependent color space of a reference display device,

applying a reference display forward color transform characterizing said reference display device to said device-dependent source coordinates R,G,B representing said mapped colors, resulting in second device-independent source coordinates X′,Y′,Z′ representing the same mapped colors in the device-independent linear color space, wherein said virtual display inverse color transform (IT_{VD}) models a virtual display device characterized:

by the same primaries as the primaries of a mastering display device used to master said source content or by primaries extracted from a description of the color gamut of said source content,

by an EOTF corresponding to that of a mastering display device used to master said source content or to that of said reference display device.

In a first variation of the above mapping method, said virtual display device is further characterized by an EOTF corresponding to that of a mastering display device used to master said source content, preferably is further characterized by a white point corresponding to that of said mastering display device. FIG. 11 illustrates this first variation of the method shown in FIG. 10, in which the virtual display is notably characterized in that it has the same primary colors, the same white point and the same EOTFs than the mastering display device.

In a second variation of the above mapping method, said virtual display device is further characterized by an EOTF corresponding to that of said reference display device, preferably further characterized by a white point corresponding to that of said reference display device. FIG. 12 illustrates this second variation of the method shown on FIG. 10, in which the virtual display is notably characterized in that it has the same white point and the same EOTFs as the reference display device, while it still has the same primary colors as the mastering display device. Since the virtual display device has the same white point as the reference display device, the mapping does not change a source color that represents the white point of the reference display device. For this source color, the mapping will output X′=X, Y′=Y, Z′=Z color coordinates. If the virtual display device has at least a white point having the same chromaticity as that of the reference display device, the same relation holds up to a scaling factor. Since the EOTFs of the virtual display device are identical to those of the reference display device, the intensity of colors and thus the overall contrast of colors is not much impacted. For example, a grey ramp of grey colors is not modified and is thus preserved. The same advantages as those described in reference to the variant illustrated on FIG. 8 are obtained.

FIG. 13 illustrates an application of this reproduction method of FIG. 10 for the reproduction of source colors on a target display device. The content is produced using a mastering display device with its own primary colors. The colors of the source content are encoded in device independent X,Y,Z color coordinates. The reference display device is compliant with the encoding standard of the video system in which the target display is integrated. For example, this encoding standard is a ITU-R BT.2020 and the video system is based on this ITU-R BT.2020 standard.

The reproduction method comprises two parts. In the first part, the mapping method illustrated on FIG. 10, or any of its variants, is applied resulting in second device independent color coordinates X′,Y′,Z′, representing mapped colors in the CIE XYZ color space.

The second part of the reproduction method, taken by its own, is already well-known. Target inverse color transform characterizing the target display device is applied to the second device independent color coordinates X′,Y′,Z′, resulting in second R′,G′,B′ device dependent color coordinates that represent the mapped colors in the color space of the target display device, and that are used to control the target display device to reproduce the source colors. In this way, the mapped color defined by the second device independent color coordinates X′,Y′,Z′ is reproduced on the target display. If said mapped color is outside of the color gamut of the target display, the target display inverse transform—according to well-known state of the art and as already described for FIG. 9—usually applies a gamut mapping algorithm, not shown in FIG. 13. Gamut mapping changes the X′,Y′,Z′ color coordinates such that after modification, the modified color is within the target display. Often, gamut compression is applied resulting in reduced saturation and reduced contrast.

Another subject of the invention is then a method for reproducing a source content on a target display device characterized by a target display inverse color transform, comprising

receiving first device-independent source coordinates X,Y,Z representing source colors of said source content,

receiving metadata representing color primaries of a mastering display device used to master said source content or extracting color primaries from a description of the color gamut of said source content,

using a virtual display inverse color transform IT_{VD} modelling a virtual display device characterized by said color primaries, mapping said source colors into mapped colors according to the mapping method above that results in device-independent mapped coordinates X′,Y′,Z′ representing said mapped colors,

applying said target display inverse color transform to said device-independent mapped coordinates X′,Y′,Z′, resulting into device-dependent mapped coordinates R′,G′,B′,

controlling said target display device by inputting said device-dependent mapped coordinates R′,G′,B′, resulting in the reproduction of said source content.

The method shown in FIG. 13 solves this issue thank to the first part of the color reproduction method. For example, if the target display device has a color gamut smaller than that of the mastering display, the first part of the color reproduction method has the effect of an expansion of colors and the second part has the effect of a compression of colors, the compression being stronger than the expansion. The loss of saturation generated by the second part is partly compensated by a gain of saturation generated by the first part. Other cases exist where the target display device has a color gamut that is larger than that of the mastering display device. For example, the first part of the method may then have the effect of an expansion of colors and the second part would have the effect of a compression of colors, the compression being weaker than the expansion. Other cases exist where the target display device has a color gamut that is larger than that of the reference display device. For example, the first part of the method may then have the effect of an expansion of colors and the second part would have the effect of an expansion, too.

The invention may have notably the following advantages:
1. As opposed to classical, known, simple color management methods based on linear matrices such as those illustrated on FIG. 1, this invention is able to consider metadata related to the primaries of the mastering display device and/or related to the source color gamut.
2. As opposed to classical, known, simple color management methods based on linear matrices and clipping such as those illustrated on FIG. 1, the method includes a color gamut mapping at the comparable computational load.
3. As shown above in reference to FIGS. 4 and 10, the color mapping method according to the invention can operate on device-dependent color coordinates or on device independent color coordinates with the same computational complexity.
4. As shown above in reference to FIGS. 8 and 12, gamut mapping methods according to the second variants above do not introduce a change of white point neither a change of electro-optical transfer function.
   Other problems that the invention may address: A first problem that the invention may address is the increased computational load required by a color mapping when it is performed in a device independent color space. For example Morovic and Luo discuss in their paper “The Fundamentals of Gamut Mapping: A Survey” published in the Journal of Imaging Science and Technology in 2001 a serous of methods requiring explicit geometrical operations in device independent color space such as calculation of gamut boundaries and line-surface intersection. As shown in FIG. 2, for such a color gamut mapping, usually, linear, colorimetric XYZ color coordinates representing a color in the device-independent CIE XYZ color space are transformed into device independent, visually uniform, so-called psycho-visual color coordinates, such as L*a*b* or JCh, to be gamut mapped in this device independent visually uniform color space. After gamut mapping, these psycho-visual color coordinates should usually be transformed back into linear, colorimetric XYZ color coordinates requiring again computational resources. The invention solves this problem since the method according to this invention is of low complexity. For example, in FIG. 9, when RP177 models are used, the operations are based on 3×3 matrices and one-dimensional EOTF functions.

A second problem that this invention may address is the consideration of metadata that can be needed for the calculation of the gamut mapping operator used to implement the color mapping method according to the invention. If such metadata changes into new metadata during the reproduction of a content by the target display device, the gamut mapping operator needs to be updated, i.e. re-calculated with the new metadata—which is usually slow. If the update is slow, the frequency of change of metadata is limited. As shown in FIG. 3, typical metadata used for classical color gamut mapping is the gamut boundary descriptions (GBD) of the source color gamut (which may be for example the color gamut of the mastering display device) and the GBD of the target color gamut of the target display device used for the reproduction of the content. The invention solves this problem since the update of the gamut mapping operator is simple. For example, in FIG. 9, when a RP177 model is used for the target display inverse transform, the change of a primary color of the mastering display require only the update—the recalculation—of a simple 3×3 linear matrix.

### BRIEF DESCRIPTION OF DRAWINGS

The invention will be more clearly understood on reading the description which follows, given by way of non-limiting example and with reference to the appended figures in which:

FIGS. 1 to 3, already mentioned, show different schemes of mapping methods according to the prior art;

FIG. 4 illustrates a general embodiment of the invention concerning a first situation where source colors to map are represented by device-dependent coordinates;

FIG. 5 illustrates the color gamut of a mastering display device in the CIE xy chromaticity space, and a position of a source color within this gamut;

FIG. 6 illustrates a technical effect of the invention;

FIG. 7 illustrates a first variation of the general embodiment shown on FIG. 4;

FIG. 8 illustrates a second variation of the general embodiment shown on FIG. 4;

FIG. 9 illustrates an application of the general embodiment shown on FIG. 4 for the reproduction of source colors on a target display device;

FIG. 10 illustrates a general embodiment of the invention concerning a second situation where source colors to map are represented by device-independent coordinates;

FIG. 11 illustrates a first variation of the general embodiment shown on FIG. 10;

FIG. 12 illustrates a second variation of the general embodiment shown on FIG. 10;

FIG. 13 illustrates an application of the general embodiment shown on FIG. 10 for the reproduction of source colors on a target display;

FIG. 14 illustrates an example of implementation of the general embodiment shown on FIG. 4;

FIG. 15 illustrates an implementation of the example of FIG. 14 on a whole image workflow;

FIGS. 16, 17, and 18 illustrates respectively a first, second, and a third example of implementation of the general embodiment shown on FIG. 10;

FIG. 19 illustrates an implementation of the general embodiment shown on FIG. 10 applied on a whole image workflow.

### DESCRIPTION OF EMBODIMENTS

It will be appreciated by those skilled in the art that block diagrams and the like presented herein represent conceptual views of illustrative circuitry embodying the invention. They may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software.

A source content is provided but is formatted to be reproduced by a reference display device, for instance as standardized according to ITU-R BT.2020, i.e. based on a wide color gamut. This source content has been mastered on a given mastering display device, notably characterized by given color primaries.

We will now describe how such source colors could be advantageously mapped into mapped colors adapted to be reproduced by a target display device: in a first situation, the mapping of source colors is performed in the reference device-dependent color space of the reference display devices; in a second situation, the mapping of source colors is performed in device-independent color space.

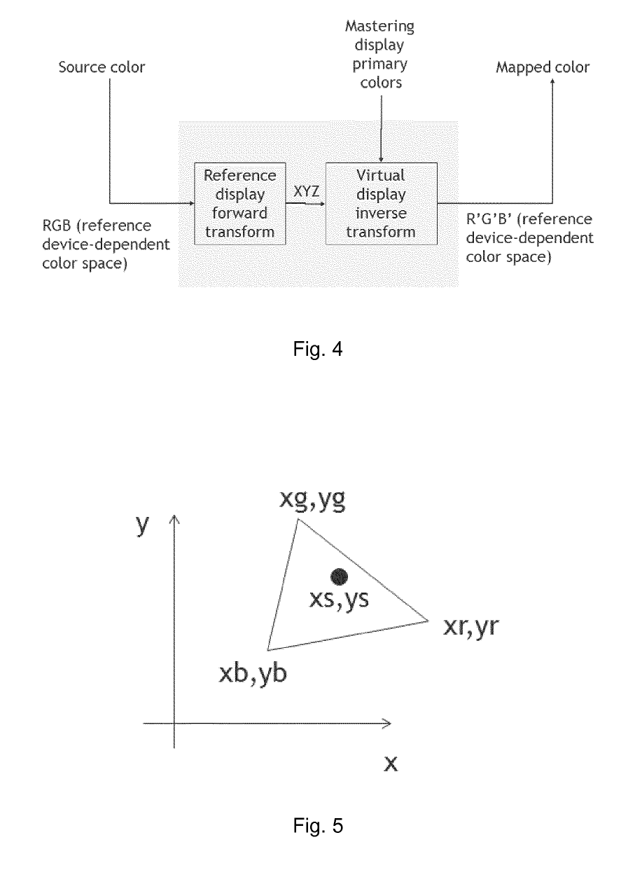

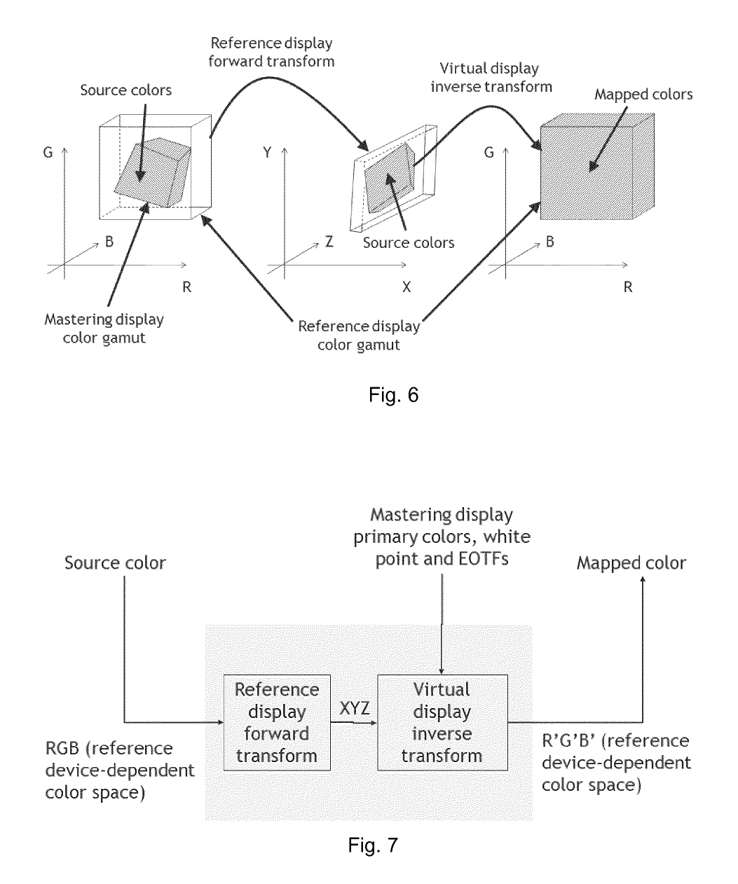

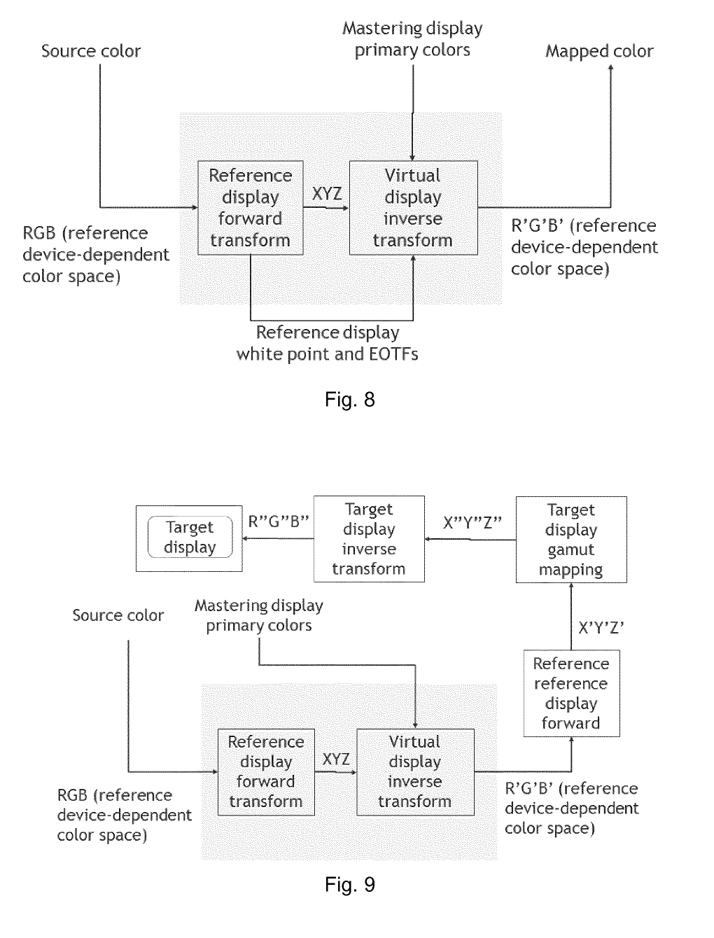

The general embodiment of a mapping in the first situation is illustrated in FIG. 4, already explained. Source colors have been produced using a given mastering display device. Most of the source colors to be mapped are hereby within the color gamut of this mastering display device (which should then be able to reproduce most of these source colors). In order to be transmitted to a target display device for reproduction, these source colors are represented, i.e. encoded, by trichromatic color coordinates R,G,B in the color space of a reference display device. The reference display device is generally different from the mastering display device, but may be equal. Usually, the color gamut of the reference display device is larger than that of the mastering display device. For example, the mastering display device can be a cinema projector with P3 color gamut while the reference display device can be a ITU-R BT.2020 compliant display device having a larger color gamut than P3. When the color gamut of the reference display device is larger than that of the mastering display device, all source colors are located in the color gamut of the reference display device (and could then be reproduced by the reference display device without any mapping).

In this general embodiment of a mapping in the first situation illustrated on FIG. 4, the method of color mapping according to the invention first transforms R,G,B color coordinates representing source colors of the source content in the color space of the reference display device into device independent color coordinates X,Y,Z representing the same colors in the CIE XYZ device independent color space, by using a forward transform RGB->XYZ modeling the reference display device. By definition, this forward transform of the reference display device is able to transform R,G,B color coordinates of any color located in the color gamut of the reference display device into X,Y,Z color coordinates defining the color that the reference display device would actually reproduce when controlled by those R,G,B color coordinates.

In a second step of this method, the method applies the inverse transform IT_{VD} of a virtual display device to the X,Y,Z color coordinates obtained from the first step above. Through this inverse transform, R′,G′,B′ device dependent color coordinates are obtained that represent mapped source colors, still in the color space of the reference display device. This virtual display device is characterized through a RP177 model (see above) by an EOTF, namely EOTF_{VD}, and a matrix M_{VD}. According to the invention, EOTF_{VD} is defined as the EOTF of the reference display device and the matrix M_{VD} is defined in reference notably to the primaries of the mastering display device according to the following equations:

$${M}_{VD} = {IM}_{VD} {W}_{VD} and {IM}_{VD} = [ \begin{matrix}{X}_{MD - R} & {X}_{MD - G} & {X}_{MD - B} \\ {Y}_{MD - R} & {Y}_{MD - G} & {Y}_{MD - B} \\ {Z}_{MD - R} & {Z}_{MD - G} & {Z}_{MD - B}\end{matrix} ]$$

$$and {W}_{VD} = [ \begin{matrix}{w}_{VD - R} & 0 & 0 \\ 0 & {w}_{VD - G} & 0 \\ 0 & 0 & {w}_{VD - B}\end{matrix} ]$$

$$and [ \begin{matrix}{w}_{VD - R} \\ {w}_{VD - G} \\ {w}_{VD - B}\end{matrix} ] = {IM}_{D}^{- 1} [ \begin{matrix}{x}_{VD - W} / {y}_{VD - W} \\ 1 \\ {z}_{VD - W} / {y}_{VD - W}\end{matrix} ] .$$

where X_{MD-R}Y_{MD-R}Z_{MD-R}, X_{MD-G}Y_{MD-G}Z_{MD-G} and X_{MD-B}Y_{MD-B}Z_{MD-B} are the X,Y,Z color coordinates of, respectively, the Red, Green and Blue primaries of the mastering display device and x_{VD-W}, y_{VD-W}, z_{VD-W} are the chromaticity coordinates of the white point of the reference display device in the XYZ color space.

We have then IT_{VD}(XYZ)=EOTF⁻¹_{VD} (M⁻¹_{VD}[XYZ]). This inverse transform IT_{VD} of the virtual display device is capable to transform XYZ coordinates of any color located within the color gamut of this virtual display device—i.e. of the mastering display device—into R′G′B′ color coordinates representing the same color in the color space of this virtual display device. The color gamut of this virtual display device consists of all colors defined by color coordinates X,Y,Z where these color coordinates X,Y,Z can be transformed by IT_{VD} into valid R′,G′,B′ color coordinates. When X,Y,Z color coordinates are valid in the range [0,1], usually valid R′G′B′ color coordinates are in the range [0,1], too.

The data defining the Red, Green and Blue primary colors of the mastering display device could be sent as metadata together with the content to be reproduced, for instance by the content creator. Such metadata can be advantageously compliant with a standard, as for instance the MPEG proposal entitled “Indication of SMPTE 2084 and 2085 and carriage of 2086 metadata in HEVC” from January 2014, which proposes color primaries as SEI metadata, defined as follows: “This SEI message provides metadata for specifying the color volume (the color primaries, white point, and luminance range) of the display that was used in mastering video content”.

If no data are available concerning the mastering display device, Red, Green and Blue primaries of the mastering display device are replaced by Red, Green and Blue primaries extracted from a gamut boundary description describing the color gamut of the source content to calculate the matrix IM_{VD} above.

As the second step above applies the inverse of the EOTF of the reference display device, this step is equivalent to a gamut mapping from the color gamut of the mastering display device to the color gamut of the reference display device.

As already explained above, source colors of the content to be reproduced by the target display device is generally within the color gamut of the mastering display device because this content is precisely generated by this mastering display device. Therefore, colors represented by X,Y,Z color coordinates obtained through the first step above are within the color gamut of the virtual display device, because this virtual display device is characterized by the same primary colors as those of the mastering display device. If these Primary colors are represented in the CIE xy chromaticity space by coordinates xr,yr for the red primary, xg,yg for the green primary, and xb,yb for the blue primary, these three primaries xr,yr and xg,yg and xb,yb form a chromaticity gamut triangle within the CIE xy chromaticity space. This gamut triangle corresponds to the color gamut of the mastering display device. As shown on FIG. 5, since any source color is generally within the color gamut of the mastering display device, its chromaticities xs,ys represented in the CIE xy are within this color gamut triangle. Since mastering and virtual displays have the same primary colors, the chromaticities xs,ys of a source color are within the gamut triangle of the virtual display, too. In general, primary colors of a display device are the main characteristics defining the color gamut of this display device. Since the virtual display device has the same primaries as the mastering display device, their gamuts are thus very close. Since the source colors are generally within the color gamut of the mastering display device, they are also within the color gamut of the virtual display device, too.

An important element of the method of color mapping of this general embodiment based on the first situation in which source colors are represented by R,G,B color coordinates is that the output R′G′B′ of the virtual display inverse transform are reference display dependent color coordinates, i.e. is that the obtained mapped colors are represented in the color space of the reference display device.

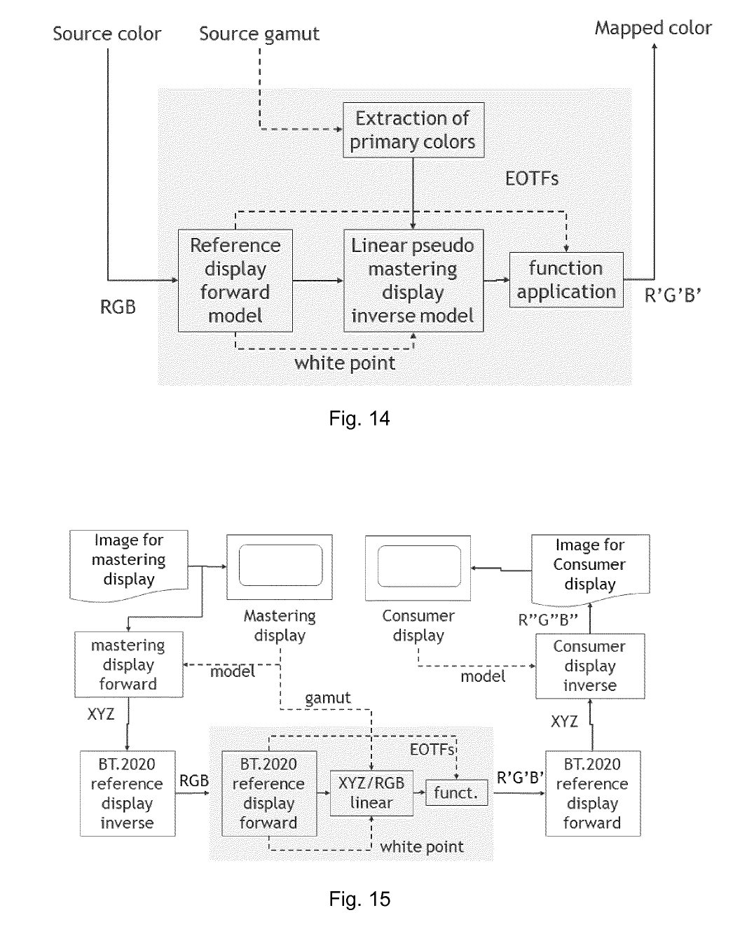

We will now describe in reference to FIG. 14 an example of implementation of the general embodiment of the first situation in which source colors to reproduced are represented by R,G,B color coordinates in the color space of the reference display device. in this example, the mapping method maps source colors of a source content from a source content color gamut in a reference color gamut. The source content color gamut may correspond to the color gamut of a mastering color display device used to master the source content, or is simply the color gamut of the source content itself. The source content color gamut is described by a gamut boundary description. The source colors are represented by device-dependent reference color coordinates R,G,B in the reference device dependent color space. The mapping described below maps the source colors into the reference color gamut. This reference color gamut is defined as the color gamut of a reference display device. This reference display device is notably characterized by a white point and a single electro-optical transfer function (EOTF)_{RD}. As already explained in detail above, this reference display device can be then modelled by a reference display device forward model FT_{RD} capable of transforming R,G,B device-dependent color coordinates into X,Y,Z reference device-independent color coordinates and/or by a reference display device inverse model IT_{RD} capable of transforming XYZ device-independent color coordinates into R′,G′,B′ reference device dependent color coordinates.

The mapping method comprises the following steps:
1. Obtaining—in a manner known per se—of primary colors from said gamut boundary description describing the source content color gamut.
2. From the obtained X_{S-R}Y_{S-R}Z_{S-R}, X_{S-G}Y_{S-G}Z_{S-G} and X_{S-B}Y_{S-B}Z_{S-B} coordinates of, respectively, the Red, Green and Blue primaries of the those primary colors in the CIE XYZ color space and from the chromaticities of the white point of the virtual display device x_{VD-W}=x_{RD-W}, y_{VD-W}=y_{RD-W}, that are set to the chromaticities x_{RD-W}, y_{RD-W}, of the white point of the reference display device, a source matrix M_{S} is computed according to:

$${M}_{S} = {IM}_{VD} {W}_{VD} and {IM}_{VD} = [ \begin{matrix}{X}_{S - R} & {X}_{S - G} & {X}_{S - B} \\ {Y}_{S - R} & {Y}_{S - G} & {Y}_{S - B} \\ {Z}_{S - R} & {Z}_{S - G} & {Z}_{S - B}\end{matrix} ]$$

$$and {W}_{VD} = [ \begin{matrix}{w}_{VD - R} & 0 & 0 \\ 0 & {w}_{VD - G} & 0 \\ 0 & 0 & {w}_{VD - B}\end{matrix} ]$$

$$and [ \begin{matrix}{w}_{VD - R} \\ {w}_{VD - G} \\ {w}_{VD - B}\end{matrix} ] = {IM}_{D}^{- 1} [ \begin{matrix}{x}_{VD - W} / {y}_{VD - W} \\ 1 \\ {z}_{VD - W} / {y}_{VD - W}\end{matrix} ] .$$

3. Applying the reference device forward model as defined above to the RGB reference device dependent source color coordinates representing the source colors to map, resulting in XYZ device independent, linear source color coordinates representing the source colors in the XYZ CIE device-independent, linear color space.
4. Applying the inverse of the computed source matrix M_{S} to these XYZ device independent, linear source color coordinates, resulting in RₗGₗBₗ device dependent, linear reference color coordinates representing the source colors in a linearized reference display color space;
5. Applying the inverse of the electro-optical transfer function EOTF_{RD} of the reference display device to the RₗGₗBₗ device dependent, linear reference color coordinates resulting in R′G′B′ final device dependent, non-linear reference color coordinates representing mapped source colors in color space of the reference display device.

As a whole, the combination of the application of the source matrix M_{S} and of the application of the inverse of the EOTF_{RD} of the reference display device is equivalent to the application of the inverse model IT_{VD} of a virtual display device such that IT_{VD} (XYZ)=EOTF⁻¹_{RD} (M⁻¹_{S}[XYZ]).

An implementation of the above example on a whole image workflow is shown in FIG. 15, from the mastering of the content through the formatting according to BT.2020 up to the final rendering of the content on a target display device, namely a consumer display such as a LCD or a tablet.

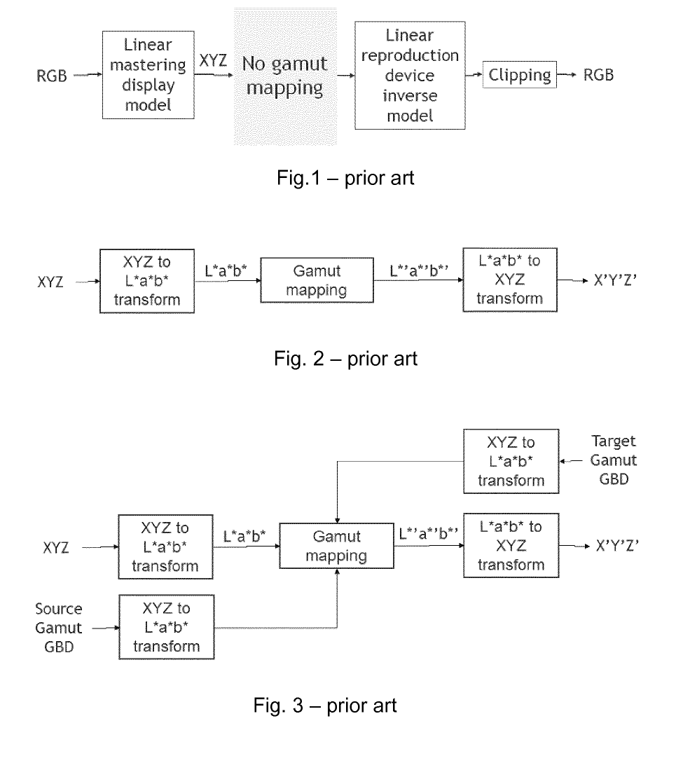

In order to ensure valid device-dependent R′G′B′ color coordinates, the coordinates are clipped after application of inverse EOTF, such as shown in FIG. 1. The workflow of FIG. 15 starts with:

mastering of the source content resulting in RGB color coordinates representing source colors in the color space of the mastering display,

application of a forward model of the mastering display then of an inverse model of the BT.2020 reference display, resulting in RGB color coordinates representing source colors in the color space of the ITU-R BT.2020 reference display,

application of the mapping method as described in the example above, resulting in R′G′B′ color coordinates representing mapped source colors in the color space of the BT.2020 reference display,

application of the forward model of the BT.2020 reference display then of an inverse model of the consumer display—i.e. target display device, resulting in R″,G″,B″ color coordinates representing mapped source colors in the color space of this consumer display, that are adapted to control this consumer display for the rendering of the source content.

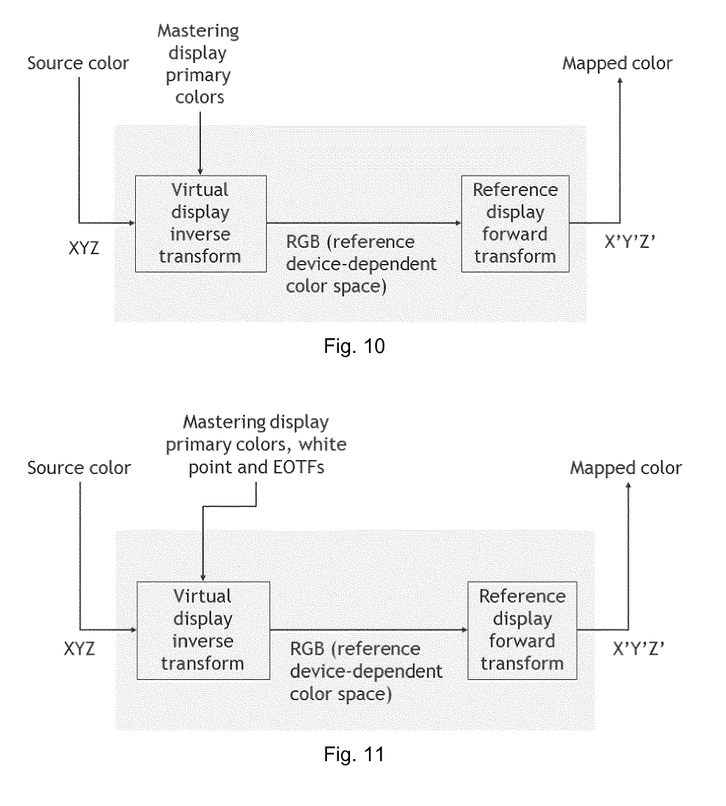

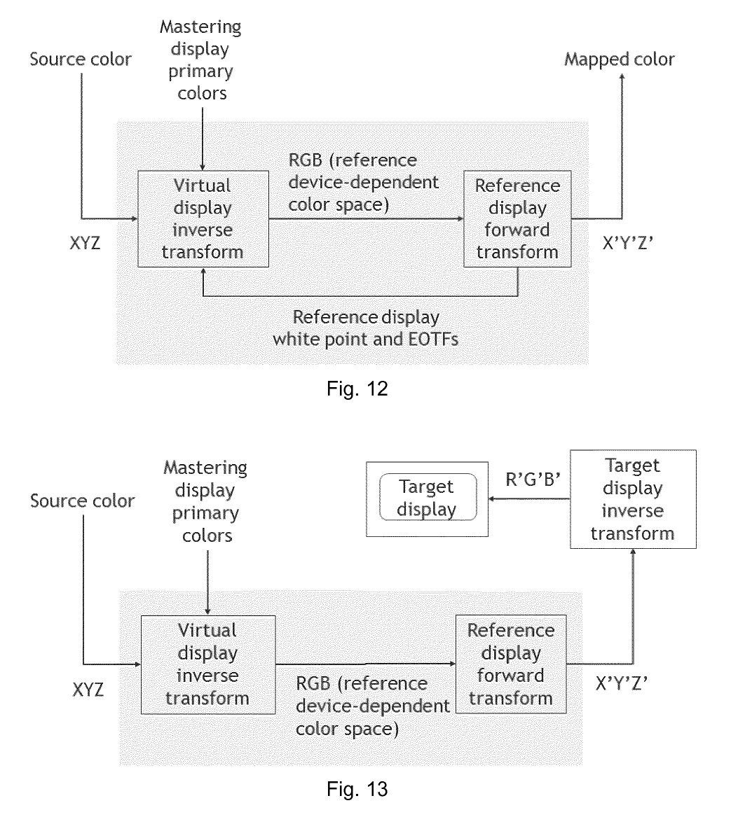

A general embodiment of a mapping in the second situation in which source colors are represented in a device-independent color space by trichromatic color coordinates X,Y,Z will be now described in reference to FIG. 10, already explained. In this embodiment, the virtual display transform IT_{VD} defined above is applied first resulting in reference display dependent color coordinates R,G,B representing mapped source colors in the color space of the reference display device. Then, device independent X′,Y′,Z′ color coordinates representing the same mapped colors in the CIE XYZ color space are obtained by applying the reference display forward transform as defined above.

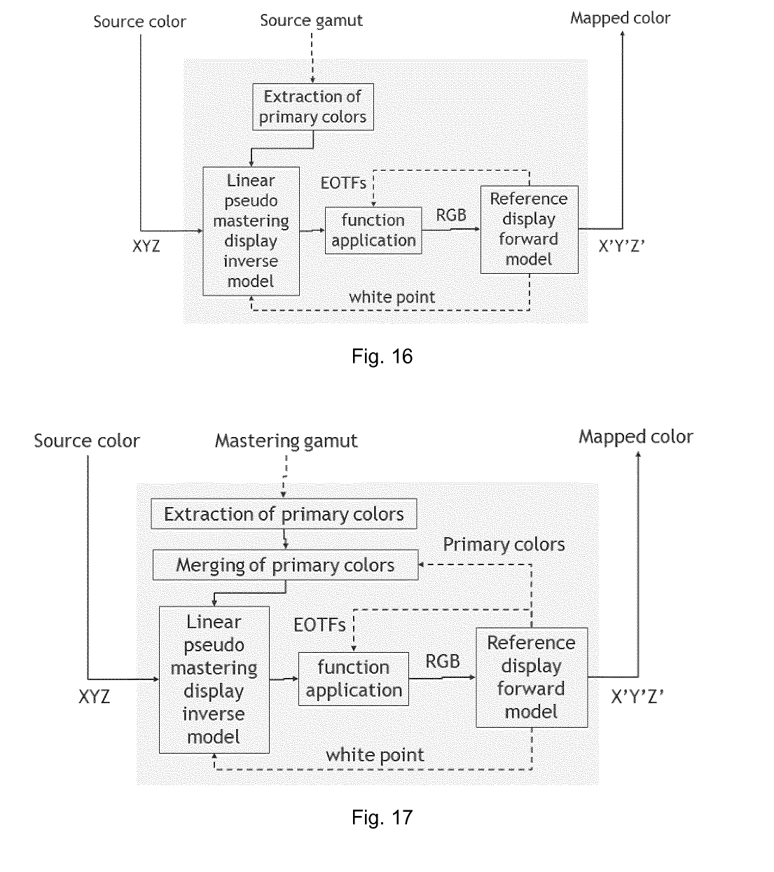

We will now describe a first example of implementation of this general embodiment in reference to FIG. 16. The source content color gamut is described by a gamut boundary description. The source colors are represented by device-independent, linear source color coordinates X,Y,Z, in the CIE XYZ color space. As already explained, the mapping of source colors maps colors towards the reference color gamut. The reference color gamut is the color gamut of the reference display device having a white point and an electro-optical transfer function (EOTF) that are used to compute the inverse transform IT_{VD} of the virtual display device.

The method comprises the following steps:
1. Extraction of primary colors from the gamut boundary description describing the source content color gamut.
2. From the extracted X_{S-R}Y_{S-R}Z_{S-R}, X_{S-G}Y_{S-G}Z_{S-G} and X_{S-B}Y_{S-B}Z_{S-B} coordinates of, respectively, the Red, Green and Blue primaries of those primary colors in the CIE XYZ color space and from the chromaticities of the white point of the virtual display device x_{VD-W}=x_{RD-W}, y_{VD-W}=y_{RD-W} that are set to the chromaticities x_{RD-W}, y_{RD-W} of the white point of the reference display device, a source matrix M_{S} is calculated as follows:

$${M}_{S} = {IM}_{VD} {W}_{VD} and {IM}_{VD} = [ \begin{matrix}{X}_{S - R} & {X}_{S - G} & {X}_{S - B} \\ {Y}_{S - R} & {Y}_{S - G} & {Y}_{S - B} \\ {Z}_{S - R} & {Z}_{S - G} & {Z}_{S - B}\end{matrix} ]$$

$$and {W}_{VD} = [ \begin{matrix}{w}_{VD - R} & 0 & 0 \\ 0 & {w}_{VD - G} & 0 \\ 0 & 0 & {w}_{VD - B}\end{matrix} ]$$

$$and [ \begin{matrix}{w}_{VD - R} \\ {w}_{VD - G} \\ {w}_{VD - B}\end{matrix} ] = {IM}_{D}^{- 1} [ \begin{matrix}{x}_{VD - W} / {y}_{VD - W} \\ 1 \\ {z}_{VD - W} / {y}_{VD - W}\end{matrix} ] .$$

3. Applying the inverse of source matrix M_{S} to the X,Y,Z device independent, linear source color coordinates representing the source colors to be mapped, resulting into RₗGₗBₗ device dependent, linear reference color coordinates.
4. Applying the inverse of the electro-optical transfer function EOTF_{RD} of the reference display device to the RₗGₗBₗ device dependent, linear reference color coordinates resulting in R′G′B′ final device dependent, non-linear reference color coordinates representing mapped source colors in color space of the reference display device.
5. Applying the reference device forward model to the R′G′B′ final device dependent, non linear reference color coordinates resulting in X′Y′Z′ device independent, linear source color coordinates representing the mapped source colors in device-independent, linear color space.

As a whole, the combination of the application of the source matrix M_{S} and of the application of the inverse of the EOTF_{RD} of the reference display device is equivalent to the application of the inverse model IT_{VD} of a virtual display device such that IT_{VD} (XYZ)=EOTF⁻¹_{RD} (M⁻¹_{S}[XYZ]).

We will now describe a second example of implementation of the general embodiment above in reference to FIG. 17. In this second example, the mapping method is amended by an additional step called “merging of primary colors” controlled by a color reproduction parameter which allows advantageously to control the mapping method according to a tradeoff between color hue fidelity and color chroma fidelity. In this second example, the primary colors are replaced by merged primary colors, the merged primary colors being a weighted average between primary colors that are extracted as shown above and primary colors of the reference display device, the weight being a color reproduction parameter computed such that the minimum value of this parameter results in that merged primary colors are identical to the extracted primary colors and such that the maximum value of this parameter results in that merged primary colors are identical to the primary colors of the reference display device.

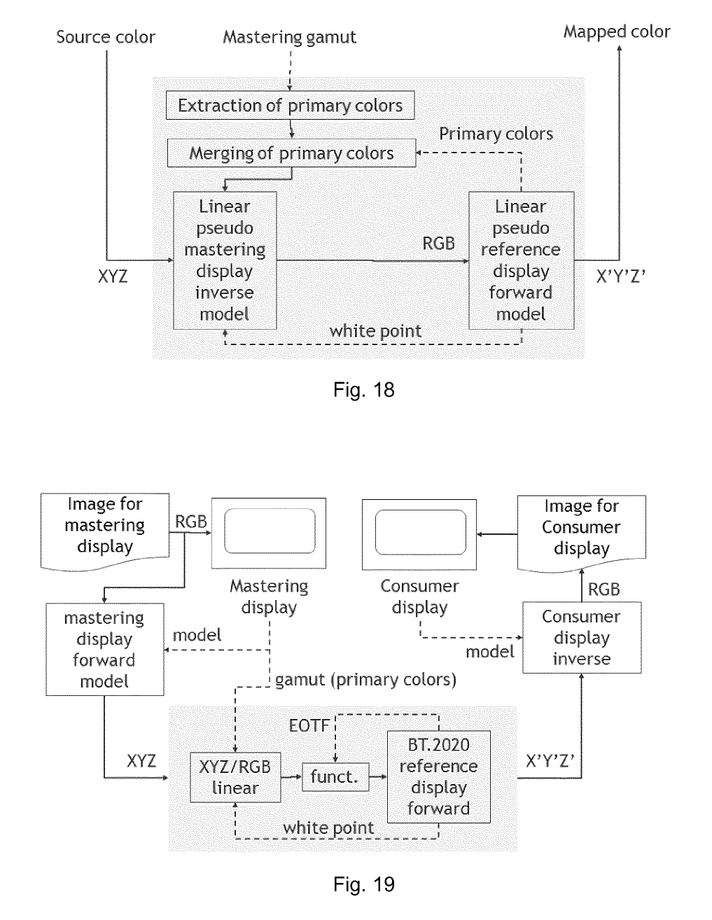

This second example can be further simplified into a third example if the reference display device and the virtual display device are characterized by the same triple of EOTFs. In this case, neither an EOTF nor an inverse EOTF needs to be applied to color coordinates. This third example is shown on FIG. 18.

An implementation of the general embodiment above applied on a whole image workflow is shown on FIG. 19, from the mastering of the content through the formatting according to BT.2020 up to the final rendering of the content on a target display device, namely a consumer display such as a LCD or a tablet. This implementation considers source content that has been produced using a source display, also called mastering display. We further consider in this implementation a UHDTV reference display compliant to ITU-R BT.2020.

This implementation is then based on the following steps:
Using a mastering display, artistic creation of an image the colors of which are represented by RGB color coordinates.
Transforming the created mastering display device-dependent color coordinates R,G,B into X,Y,Z device-independent color coordinates using a forward model of the mastering display.
Describing the source color gamut of the mastering display using X,Y,Z color coordinates of at least the red, green and blue as primary colors. These colors are measured using a colorimeter as output of the display controlled by at least three input signals. In case of a mastering display having 8 bit encoded R,G,B inputs, the input signals are (255,0,0), (0,255,0), (0,0,255), (255,0,255), respectively.
Using SMPTE RP177 modeling of a display device, calculating from these primary colors and from the white point of the reference display a linear matrix M_{MD} transforming device independent color coordinates into linear, pseudo device-dependent color coordinates:

$${M}_{MD} = {IM}_{VD} {W}_{VD} with {IM}_{MD} = [ \begin{matrix}{X}_{MD - R} & {X}_{MD - G} & {X}_{MD - B} \\ {Y}_{MD - R} & {Y}_{MD - G} & {Y}_{MD - B} \\ {Z}_{MD - R} & {Z}_{MD - G} & {Z}_{MD - B}\end{matrix} ]$$

$$and {W}_{VD} = [ \begin{matrix}{w}_{VD - R} & 0 & 0 \\ 0 & {w}_{VD - G} & 0 \\ 0 & 0 & {w}_{VD - B}\end{matrix} ]$$

$$and [ \begin{matrix}{w}_{VD - R} \\ {w}_{VD - G} \\ {w}_{VD - B}\end{matrix} ] = {IM}_{D}^{- 1} [ \begin{matrix}{x}_{RD - W} / {y}_{RD - W} \\ 1 \\ {z}_{RD - W} / {y}_{RD - W}\end{matrix} ] .$$

where X_{MD-R}Y_{MD-R}Z_{MD-R}, X_{MD-G}Y_{MD-G}Z_{MD-G} and X_{MD-B}Y_{MD-B}Z_{MD-B} are the XYZ color coordinates of, respectively, the Red, Green and Blue primaries of the mastering display device and x_{RD-W}, y_{RD-W}, y_{zRD-W} are the chromaticity coordinates of the white point of the reference display device in the xy chromaticity space.
Applying this linear matrix to the XYZ device-independent, linear source color coordinates, resulting into RₗGₗBₗ device dependent, linear reference color coordinates.
Applying the inverse of the (usually non-linear) electro-optical transfer function (EOTF) of the reference display device resulting into non-linear, pseudo device dependent color coordinates.
Assuming as reference display an ITU-R BT.2020 compliant display, applying the inverse EOTF of this ITU-R BT.2020 compliant display to the non-linear, pseudo device-dependent color coordinates, and applying then a second linear matrix calculated from the primary colors and the white color of the ITU BT.2020 compliant display, resulting into device independent color coordinates X′Y′Z′ representing mapped colors.
Applying the inverse transform characterizing the consumer display used to reproduced the source colors, resulting in RGB color coordinates adapted to control this consumer display.

It is to be understood that the mapping method according to the invention may be implemented in various forms of hardware, software, firmware, special purpose processors, or combinations thereof. The invention may be notably implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

Therefore, further subjects of the invention are summarized below.

A subject of the invention is notably a color mapping device for mapping source colors of a source content, wherein said source colors are represented by device-dependent source coordinates R,G,B in the reference device-dependent color space of a reference display device characterized by a reference display forward color transform comprising:

a reference display forward color transform module configured for applying said reference display forward color transform to device-dependent source coordinates (R,G,B) representing said source colors, resulting in device-independent source coordinates (X,Y,Z) representing the same source colors in a device-independent linear color space,

a virtual display inverse color transform module configured for applying a virtual display inverse color transform (IT_{VD}) to the device-independent source coordinates X,Y,Z provided by said reference display forward color transform module, resulting in device-dependent mapped coordinates R′,G′,B′ representing mapped colors in said reference device-dependent color space, wherein said virtual display inverse color transform (IT_{VD}) models a virtual display device characterized by the same primaries as the primaries of a mastering display device used to master said source content or by primaries extracted from a description of the color gamut of said source content.

A subject of the invention is also a color mapping device for mapping source colors of a source content, wherein said source colors are represented by first device-independent source coordinates X,Y,Z in a device-independent color space comprising:

a virtual display inverse color transform module configured for applying a virtual display inverse color transform (IT_{VD}) to said device-independent source coordinates X,Y,Z representing said source colors, resulting in device-dependent mapped coordinates R,G,B representing mapped colors in the reference device-dependent color space of a reference display device characterized by a reference display forward color transform,

a reference display forward color transform module configured for applying said reference display forward color transform to device-dependent mapped coordinates R,G,B provided by said virtual display inverse color transform module, resulting in device-independent mapped coordinates X′,Y′,Z′ representing the same mapped colors in the device-independent linear color space,

wherein said virtual display inverse color transform (IT_{VD}) models a virtual display device characterized by the same primaries as the primaries of a mastering display device used to master said source content or by primaries extracted from a description of the color gamut of said source content.

A subject of the invention is also a target display device characterized by a target display inverse color transform characterized by a target display inverse color transform, configured for reproducing a source content, comprising

a reception module configured for receiving device-dependent source coordinates R,G,B representing source colors of said source content in the reference device-dependent color space of a reference display device characterized by a reference display forward color transform,

a color primaries module configured to provide color primaries received as metadata representing color primaries of a mastering display device used to master said source content or extracted from a description of the color gamut of said source content,

a color mapping device as summarized above that is configured to map device-dependent source coordinates R,G,B provided by said reception module, using a virtual display inverse color transform (IT_{VD}) modelling a virtual display device characterized by color primaries provided by said color primaries module, resulting in device-dependent mapped coordinates R′,G′,B′ representing said mapped colors,

a final color transform module configured to apply said reference display forward color transform and said target display inverse color transform to device-dependent mapped coordinates R′,G′,B′ provided by said color mapping device, resulting into device-independent mapped coordinates X′,Y′,Z′ representing said mapped colors in device-independent color space, configured to gamut map said device-independent mapped coordinates X′,Y′,Z′ from said reference color gamut towards said target color gamut and to apply said target display inverse color transform to said gamut-mapped device-independent mapped coordinates X″,Y″,Z″, resulting into device-dependent target coordinates R″,G″,B″ representing said mapped colors in the target device-dependent color space of said target display device,

a target display control module configured to control said target display device by inputting device-dependent mapped coordinates R″,G″,B″ provided by said final color transform module, resulting in the reproduction of said source content.

A subject of the invention is also a target display device characterized by a target display inverse color transform characterized by a target display inverse color transform, configured for reproducing a source content, comprising:

a reception module configured for receiving device-independent source coordinates X,Y,Z representing source colors of said source content,

a color primaries module configured to provide color primaries received as metadata representing color primaries of a mastering display device used to master said source content or extracted from a description of the color gamut of said source content,

a color mapping device as summarized above that is configured to map device-independent source coordinates X,Y,Z provided by said reception module, using a virtual display inverse color transform (IT_{VD}) modelling a virtual display device characterized by color primaries provided by said color primaries module, resulting in device-independent mapped coordinates X′,Y′,Z′ representing said mapped colors,

a final color transform module configured to apply said target display inverse color transform to device-independent mapped coordinates X′,Y′,Z′ provided by said color mapping device, resulting into device-dependent mapped coordinates R′,G′,B′,

a target display control module configured to control said target display device by inputting device-dependent mapped coordinates R′,G′,B′ provided by said final color transform module, resulting in the reproduction of said source content.

Although the illustrative embodiments of the invention have been described herein with reference to the accompanying drawings, it is to be understood that the present invention is not limited to those precise embodiments, and that various changes and modifications may be effected therein by one of ordinary skill in the pertinent art without departing from the invention. All such changes and modifications are intended to be included within the scope of the present invention as set forth in the appended claims.

1-14. (canceled)

15. A method of mapping source colors of a source content, wherein said source colors are represented by device-dependent source coordinates R,G,B in the reference device-dependent color space of a reference display device characterized by a reference display forward color transform comprising:
applying said reference display forward color transform to device-dependent source coordinates (R,G,B) representing said source colors, resulting in device-independent source coordinates (X,Y,Z) representing the same source colors in a device-independent linear color space,
applying a virtual display inverse color transform (IT_{VD}) to said resulting device-independent source coordinates X, Y, Z representing said source colors, resulting in device-dependent mapped coordinates R′, G′, B′ representing mapped colors in said reference device-dependent color space,
wherein said virtual display inverse color transform (IT_{VD}) models a virtual display device characterized by the same primaries as the primaries of a mastering display device used to master said source content or by primaries extracted from a description of the color gamut of said source content.

16. The method according to claim 15 wherein said virtual display device is further characterized by an EOTF corresponding to that of a mastering display device used to master said source content.

17. The method according to claim 15 wherein said virtual display device is further characterized by an EOTF corresponding to that of said reference display device.

18. The method according to claim 17 wherein said virtual display device is further characterized by a white point corresponding to that of said reference display device.

19. A method of mapping source colors of a source content, wherein said source colors are represented by first device-independent source coordinates X, Y, Z in a device-independent color space comprising:
applying a virtual display inverse color transform (IT_{VD}) to said device-independent source coordinates X,Y,Z representing said source colors, resulting in device-dependent source coordinates R,G,B representing mapped colors in the reference device-dependent color space of a reference display device,
applying a reference display forward color transform characterizing said reference display device to said device-dependent source coordinates R,G,B representing said mapped colors, resulting in second device-independent source coordinates X′,Y′,Z′ representing the same mapped colors in the device-independent linear color space,
wherein said virtual display inverse color transform (IT_{VD}) models a virtual display device characterized:
by the same primaries as the primaries of a mastering display device used to master said source content or by primaries extracted from a description of the color gamut of said source content,
by an EOTF corresponding to that of a mastering display device used to master said source content or to that of said reference display device.

20. The method according to claim 19 wherein said virtual display device is further characterized by an EOTF corresponding to that of a mastering display device used to master said source content.

21. The method according to claim 19 wherein said virtual display device is further characterized by an EOTF corresponding to that of said reference display device.

22. The method according to claim 21 wherein said virtual display device is further characterized by a white point corresponding to that of said reference display device.

23. The method for reproducing a source content on a target display device characterized by a target display inverse color transform, comprising:
receiving device-dependent source coordinates R, G, B representing source colors of said source content in the reference device-dependent color space of a reference display device characterized by a reference display forward color transform,
receiving metadata representing color primaries of a mastering display device used to master said source content or extracting color primaries from a description of the color gamut of said source content,
using a virtual display inverse color transform (IT_{VD}) modelling a virtual display device characterized by said color primaries, mapping said source colors into mapped colors according to the method of claim 15, resulting in device-dependent mapped coordinates R′, G′, B′ representing said mapped colors,
applying said reference display forward color transform to said device-dependent mapped coordinates R′, G′, B′, resulting into device-independent mapped coordinates X′, Y′, Z′ representing said mapped colors in device-independent color space,
gamut mapping said device-independent mapped coordinates X′, Y′, Z′ from said reference color gamut towards said target color gamut and applying said target display inverse color transform to said gamut-mapped device-independent mapped coordinates X″, Y″, Z″, resulting into device-dependent target coordinates R″, G″, B″ representing said mapped colors in the target device-dependent color space of said target display device,
controlling said target display device by inputting said device-dependent target coordinates R″, G″, B″, resulting in the reproduction of said source content.

24. The method for reproducing a source content on a target display device characterized by a target display inverse color transform, comprising:
receiving first device-independent source coordinates X, Y, Z representing source colors of said source content,
receiving metadata representing color primaries of a mastering display device used to master said source content or extracting color primaries from a description of the color gamut of said source content,
using a virtual display inverse color transform (IT_{VD}) modelling a virtual display device characterized by said color primaries, mapping said source colors into mapped colors according to the method of claim 19, resulting in device-independent mapped coordinates X′, Y′, Z′ representing said mapped colors,
applying said target display inverse color transform to said device-independent mapped coordinates X′, Y′, Z′, resulting into device-dependent mapped coordinates R′, G′, B′,
controlling said target display device by inputting said device-dependent mapped coordinates R′, G′, B′, resulting in the reproduction of said source content.

25. A color processing device for mapping source colors of a source content, wherein said source colors are represented by device-dependent source coordinates R, G, B in the reference device-dependent color space of a reference display device characterized by a reference display forward color transform, comprising:
a reference display forward color transform module configured for applying said reference display forward color transform to device-dependent source coordinates (R, G, B) representing said source colors, resulting in device-independent source coordinates (X, Y, Z) representing the same source colors in a device-independent linear color space,
a virtual display inverse color transform module configured for applying a virtual display inverse color transform (IT_{VD}) to the device-independent source coordinates X, Y, Z provided by said reference display forward color transform module, resulting in device-dependent mapped coordinates R′,G′,B′ representing mapped colors in said reference device-dependent color space,
wherein said virtual display inverse color transform (IT_{VD}) models a virtual display device characterized by the same primaries as the primaries of a mastering display device used to master said source content or by primaries extracted from a description of the color gamut of said source content.

26. The color processing device according to claim 25 wherein said virtual display device is further characterized by an EOTF corresponding to that of a mastering display device used to master said source content.

27. The color processing device according to claim 25 wherein said virtual display device is further characterized by an EOTF corresponding to that of said reference display device.

28. The color processing device according to claim 27 wherein said virtual display device is further characterized by a white point corresponding to that of said reference display device.

29. A color processing device for mapping source colors of a source content, wherein said source colors are represented by first device-independent source coordinates X, Y, Z in a device-independent color space, comprising:
a virtual display inverse color transform module configured for applying a virtual display inverse color transform (IT_{VD}) to said device-independent source coordinates X, Y, Z representing said source colors, resulting in device-dependent mapped coordinates R, G, B representing mapped colors in the reference device-dependent color space of a reference display device characterized by a reference display forward color transform,
a reference display forward color transform module configured for applying said reference display forward color transform to device-dependent mapped coordinates R, G, B provided by said virtual display inverse color transform module, resulting in device-independent mapped coordinates X′, Y′, Z′ representing the same mapped colors in the device-independent linear color space,
wherein said virtual display inverse color transform (IT_{VD}) models a virtual display device characterized by the same primaries as the primaries of a mastering display device used to master said source content or by primaries extracted from a description of the color gamut of said source content.

30. The color processing device according to claim 29 wherein said virtual display device is further characterized by an EOTF corresponding to that of a mastering display device used to master said source content.

31. The color processing device according to claim 29 wherein said virtual display device is further characterized by an EOTF corresponding to that of said reference display device.

32. The color processing device according to claim 31 wherein said virtual display device is further characterized by a white point corresponding to that of said reference display device.

33. A target display device characterized by a target display inverse color transform configured for reproducing a source content, comprising:
a reception module configured for receiving device-dependent source coordinates R, G, B representing source colors of said source content in the reference device-dependent color space of a reference display device characterized by a reference display forward color transform,
a color primaries module configured to provide color primaries received as metadata representing color primaries of a mastering display device used to master said source content or extracted from a description of the color gamut of said source content,
a color processing device according to claim 25, configured to map device-dependent source coordinates R, G, B provided by said reception module, using a virtual display inverse color transform (IT_{VD}) modelling a virtual display device characterized by color primaries provided by said color primaries module, resulting in device-dependent mapped coordinates R′, G′, B′ representing said mapped colors,
a final color transform module configured to apply said reference display forward color transform and said target display inverse color transform to device-dependent mapped coordinates R′, G′, B′ provided by said color mapping device, resulting into device-independent mapped coordinates X′, Y′, Z′ representing said mapped colors in device-independent color space, configured to gamut map said device-independent mapped coordinates X′, Y′, Z′ from said reference color gamut towards said target color gamut and to apply said target display inverse color transform to said gamut-mapped device-independent mapped coordinates X″, Y″, Z″, resulting into device-dependent target coordinates R″, G″, B″ representing said mapped colors in the target device-dependent color space of said target display device,
a target display control module configured to control said target display device by inputting device-dependent mapped coordinates R″, G″, B″ provided by said final color transform module, resulting in the reproduction of said source content.

34. A target display device characterized by a target display inverse color transform, configured for reproducing a source content, comprising:
a reception module configured for receiving device-independent source coordinates X, Y, Z representing source colors of said source content,
a color primaries module configured to provide color primaries received as metadata representing color primaries of a mastering display device used to master said source content or extracted from a description of the color gamut of said source content,
a color processing device according to claim 29, configured to map device-independent source coordinates X, Y, Z provided by said reception module, using a virtual display inverse color transform (IT_{VD}) modelling a virtual display device characterized by color primaries provided by said color primaries module, resulting in device-independent mapped coordinates X′, Y′, Z′ representing said mapped colors, a final color transform module configured to apply said target display inverse color transform to device-independent mapped coordinates X′, Y′, Z′ provided by said color mapping device, resulting into device-dependent mapped coordinates R′, G′, B′,
a target display control module configured to control said target display device by inputting device-dependent mapped coordinates R′, G′, B′ provided by said final color transform module, resulting in the reproduction of said source content.

35. A computer readable storage medium comprising stored instructions that when executed by at least one processor performs the method of claim 15.

36. A computer readable storage medium comprising stored instructions that when executed by at least one processor performs the method of claim 19.

37. A computer readable storage medium comprising stored instructions that when executed by at least one processor performs the method of claim 23.

38. A computable readable storage medium comprising stored instructions that when executed by at least one processor performs the method of claim 24.
